(19) United States
(12) Patent Application Publication
(10) Pub. No.: US 2025/0382758 A1
(43) Pub. Date: Dec. 18, 2025

(54) SNOW BLOWER

(71) Applicant: Milwaukee Electric Tool Corporation, Brookfield, WI (US)

(72) Inventors: Nicholas J. Block, Milwaukee, WI (US); Mark J. Frykman, Mequon, WI (US); Jonathan S. Keller, Menomonee Falls, WI (US); Ryan Frederickson, Brookfield, WI (US)

(21) Appl. No.: 19/233,795

(22) Filed: Jun. 10, 2025

Related U.S. Application Data
(60) Provisional application No. 63/660,099, filed on Jun. 14, 2024.

(51) Int. Cl. E01H 5/09

(52) U.S. Cl. CPC E01H 5/098

(57) ABSTRACT

A snow blower may include a frame, a rotatable auger, and a battery compartment. The rotatable auger rotatably may be mounted to the frame. The battery compartment may be attached to the frame to receive a battery pack. The battery compartment may include a battery terminal in selective electrical communication with the battery pack. The battery compartment may also include a guide rail extending above the battery terminal. The deflector plate may be movably mounted above the battery terminal to move between an obstructed position and an unobstructed position. The obstructed position may include the deflector plate extended across at least a portion of the guide rail directly above the battery terminal to cover the battery terminal. The unobstructed position may include the deflector plate horizontally spaced apart from the battery terminal to uncover the battery terminal.

### CROSS-REFERENCE TO RELATED APPLICATIONS

The present application claims priority to U.S. Patent Application No. 63/660,099 filed on Jun. 14, 2025, the disclosure of which is incorporated by reference herein in its entirety.

### FIELD OF THE DISCLOSURE

The present disclosure relates generally to outdoor power tools, such as snow blower power tools.

### BACKGROUND OF THE DISCLOSURE

Power tools are generally utilized to make working conditions easier. For example, snow blowers eliminate the need for shoveling snow. Instead of manually lifting snow from a surface (e.g., a driveway or sidewalk) to move the snow therefrom, the operator can push or walk a snow blower through the snow. The snow blower lifts the snow and discharges it a distance from the underlying surface. Typically, this involves moving snow from a rotating auger to a downstream chute that can direct the moving snow away from the snow blower. In this regard, snow blowers make snow removal easier than previous manual operations.

### BRIEF DESCRIPTION OF THE DISCLOSURE

Although snow blowers can greatly reduce the amount of human effort to clear an area of snow, existing appliances still maintain certain drawbacks during use. For instance, battery-powered snow blowers may have limited runtime and may require one or more batteries to be changed and recharged during a snow blowing operation. Moreover, the area in which batteries are inserted may be exposed to the elements such snow or debris may fall into an area in which a battery is received. For instance, it may be inconvenient or difficult for a user to insert or swap a battery while also blocking or preventing snow from entering the battery-receiving area. This may, in turn, add to a user's frustration, hinder tool performance, or reduce durability.

Accordingly, snow blowers, features, or methods of operation are desired in the art. In particular, systems or methods that enhance ease of use and convenience for a user, such as by mitigating the accumulation of snow or debris near a battery-receiving area or battery terminal, would be advantageous.

Aspects and advantages of the invention will be set forth in part in the following description, or may be obvious from the description, or may be learned through practice of the invention.

In one exemplary aspect of the present disclosure, a snow blower is provided. The snow blower may include a frame, a rotatable auger, and a battery compartment. The rotatable auger rotatably may be mounted to the frame. The battery compartment may be attached to the frame to receive a battery pack. The battery compartment may include a battery terminal in selective electrical communication with the battery pack. The battery compartment may also include a guide rail extending above the battery terminal. The deflector plate may be movably mounted above the battery terminal to move between an obstructed position and an unobstructed position. The obstructed position may include the deflector plate extended across at least a portion of the guide rail directly above the battery terminal to cover the battery terminal. The unobstructed position may include the deflector plate horizontally spaced apart from the battery terminal to uncover the battery terminal.

In another exemplary aspect of the present disclosure, a snow blower is provided. The snow blower may include a frame, a rotatable auger, and a battery compartment. The rotatable auger may be rotatably mounted to the frame. The battery compartment may be attached to the frame to receive a battery pack. The battery compartment may include a battery terminal in selective electrical communication with the battery pack. The battery compartment may also include a guide rail extending above the battery terminal. The guide rail may define a vertical channel within which the battery pack is slidably disposed. The battery compartment may further include a deflector plate movably mounted above the battery terminal to move between an obstructed position and an unobstructed position. The obstructed position may include the deflector plate extended directly above the battery terminal from a rear portion of the vertical channel to a front portion of the vertical channel to cover the battery terminal. The unobstructed position may include the deflector plate horizontally spaced apart from the battery terminal to uncover the battery terminal.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 is a perspective view of a snow blower in accordance with exemplary embodiments of the present disclosure.

FIG. 2 is a side elevation view of a portion of a snow blower in accordance with exemplary embodiments of the present disclosure.

FIG. 3 provides an overhead perspective view of a battery compartment of a snow blower in accordance with exemplary embodiments of the present disclosure.

FIG. 4 provides another perspective view of a battery compartment of a snow blower in accordance with exemplary embodiments of the present disclosure.

FIG. 5 provides a perspective view of a portion of the exemplary battery compartment of FIG. 4, wherein a deflector plate is provided in an obstructed position.

FIG. 6 provides a perspective view of a portion of the exemplary battery compartment of FIG. 4, wherein a deflector plate is provided in an unobstructed position.

Repeat use of reference characters in the present specification and drawings is intended to represent the same or analogous features or elements of the present invention.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present). A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

Exemplary aspects of the present disclosure may include one or more features to advantageously block a battery terminal from snow, such as when a battery is absent from a battery compartment. The battery terminal may be notably accessed or uncovered from the blocking features (e.g., automatically or without additional input from a user) by inserting a battery pack within the battery compartment or otherwise mating the battery pack to the battery terminal.

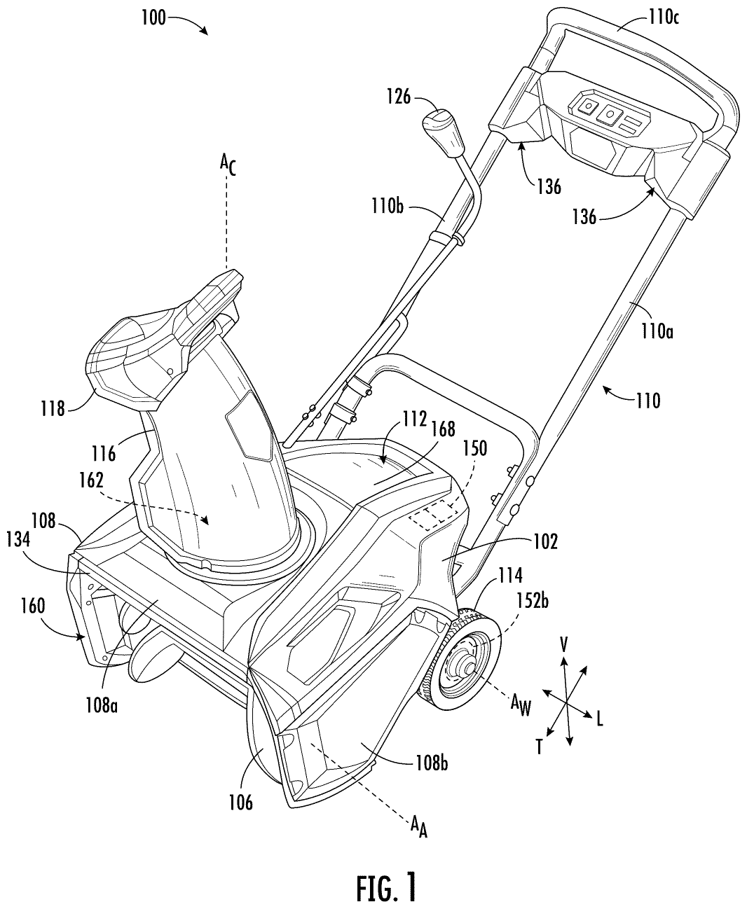

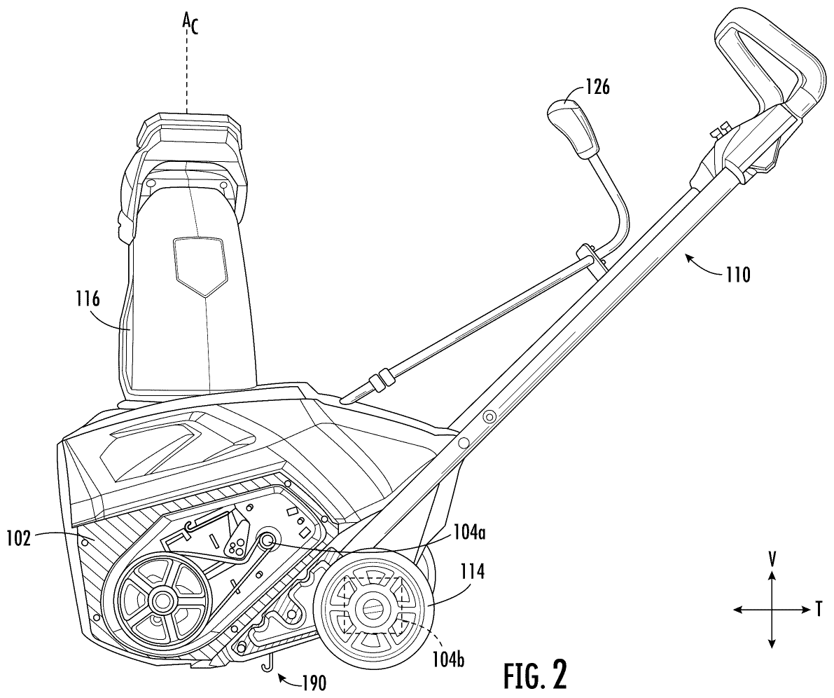

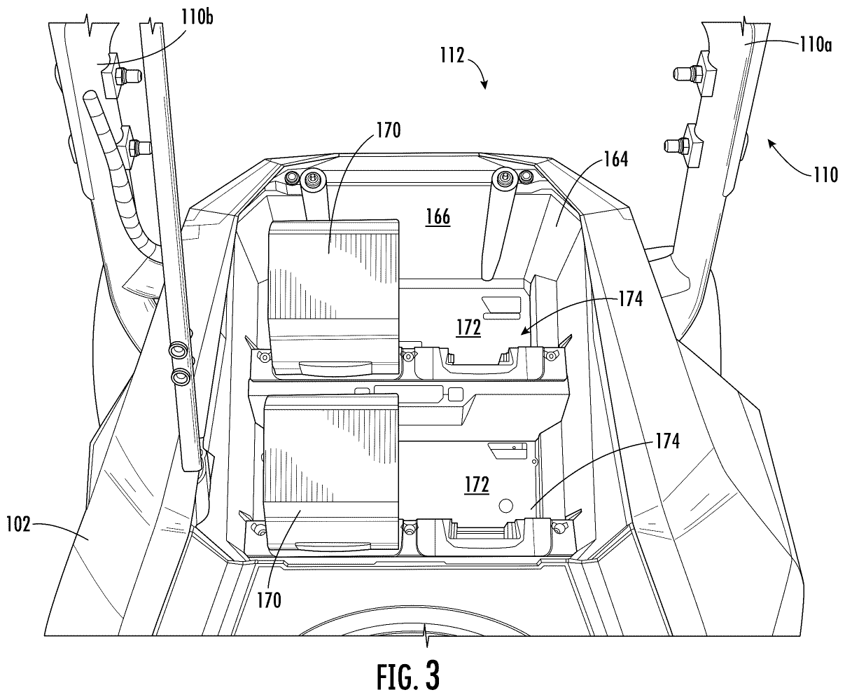

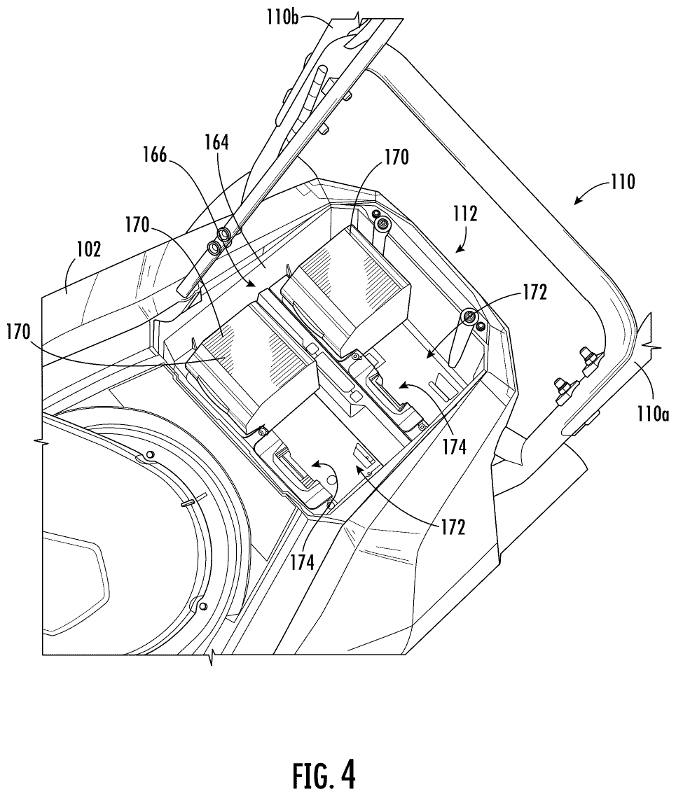

Referring now to the drawings, FIGS. 1 and 2 illustrate a snow blower 100 in accordance with various exemplary embodiments of the present disclosure. Generally, snow blower 100 defines a mutually orthogonal vertical direction V, lateral direction L, and transverse direction T. The snow blower 100 includes a frame 102, one or more motors 104 (e.g., element motor 104a or wheel motor 104b) and an auger 106 coupled (e.g., rotatably mounted) to the frame 102 (e.g., disposed in auger housing 108) to rotate about a defined auger axis A_{A}. Snow blower 100 may further include a handle assembly 110 extending from the frame 102. As illustrated, the handle assembly 110 can extend from a rear end of the frame 102 in a generally vertical direction V. A battery compartment 112 having a cover 168 can be coupled to the frame 102 to receive one or more batteries or battery packs 170 (FIGS. 3 and 4) which can provide power to the one or more motors 104a, 104b (e.g., one more electric motors). In other embodiments, one or more motors 104a, 104b can include an engine powered by fuel. In such embodiments, a fuel storage tank (not illustrated) may be provided to store fuel for powering the engine.

The snow blower 100 is supported by one or more walking elements (e.g., wheels 114). Generally, one or more wheels 114 define a wheel axis Aw (e.g., parallel to the lateral direction L) about which the wheels 114 rotate. In optional embodiments, the wheels 114 are provided as a pair of driven wheels that can be driven or rotated by a discrete wheel motor 104b (e.g., separate from element motor 104a). As illustrated, the wheel motor 104b may be supported on the frame 102 apart from the element motor 104a. Although the driven wheels 114 may be motivated or rotated by wheel motor 104b, an operator or user may selectively push the snow blower 100 (e.g., manually).

It is noted that although the illustrated snow blower 100 is shown as a single-stage snow blower, the present disclosure is not limited to the same and may be applicable to any suitable snow blowing power tool, such as a dual-stage (e.g., impeller) snow blower, self-propelled snow blower, manually propelled or push snow blower, etc.

In some embodiments, a controller 150 may be provided in operative communication with one or more components of snow blower 100 (e.g., motors 104a, 104b, sensors 152a, 152b, etc.). The controller 150 may include a memory and one or more microprocessors, CPUs or the like, such as general or special purpose microprocessors operable to execute programming instructions or micro-control code associated with operation of snow blower 100. The memory may represent random access memory such as DRAM, or read only memory such as ROM or FLASH. In some embodiments, the processor executes non-transitory programming instructions stored in memory. For certain embodiments, the instructions include a software package configured to operate snow blower 100 or execute an operation routine. The memory may be a separate component from the processor or may be included onboard within the processor. Alternatively, controller 150 may be constructed without using a microprocessor (e.g., using a combination of discrete analog or digital logic circuitry; such as switches, amplifiers, integrators, comparators, flip-flops, AND gates, and the like) to perform control functionality instead of relying upon software.

Controller 150 may be positioned in a variety of locations throughout snow blower 100. Input/output (“I/O”) signals may be routed between controller 150 and various operational components of snow blower 100. One or more components of snow blower 100 may be in operative communication (e.g., electric communication) with controller 150 via one or more conductive signal lines or shared communication busses.

In optional embodiments, one or more operational sensors 152a, 152b are provided on snow blower 100 in operative (e.g., wired or wireless) communication with controller 150. Generally, such operational sensors 152a, 152b are configured to detect one or more operational conditions of the snow blower 100 and transmit signals corresponding to the same (e.g., to controller 150). Such operational conditions may be related to performance of the snow blower 100. As an example, a motor sensor 152a may be provided (e.g., at controller 150) to detect a motor loading signal received from the auger motor 104a according to an operational load (e.g., voltage draw) on the auger motor 104a. Such motor loading signals and sensors 152a, 152b for the same are generally understood. As an additional or alternative, example, a speed sensor 152b may be mounted on frame 102 and configured to detect a velocity of the snow blower 100. The detected velocity may generally correspond to forward movement of the snow blower 100. For instance, speed sensor 152b may detect velocity based on a rotational speed of one or more wheels 114. To that end, and as would be understood the speed sensor 152b may include a rotational sensor (e.g., Hall effect sensor, inductive sensor, eddy-current sensor, photodiode array, etc.) be configured to detect rotational movement at the wheels 114 (or an axle thereof).

Optionally, the snow blower 100 can include one or more lighting elements (e.g., one or more light emitting diodes, commonly referred to as LEDs) configured to illuminate one or more areas of the environment in which the snow blower 100 is operating. For example, the snow blower 100 can include one or more light 134 (e.g., including one or more light emitting diodes, fluorescent bulbs, halogen bulbs, incandescent bulbs, etc.) disposed on the auger housing 108. The light 134 can be disposed on a front portion of the auger housing 108 so as to illuminate an area in front of the snow blower 100 during operation (e.g., an area of snow to be treated with the snow blower 100). Additionally or alternatively, the snow blower 100 can include one or more light or light units 136 (e.g., including one or more light emitting diodes, fluorescent bulbs, halogen bulbs, incandescent bulbs, etc.) configured to illuminate a path cleared by the snow blower 100. For instance, the light unit(s) 136 can be mounted on the handle assembly 110, a control panel 120, or any other suitable location to illuminate in a direction rearward from a path cleared by the auger 106.

The auger housing 108 generally houses the auger 106 (e.g., such that the auger 106 is housed below the top wall 108a and rearward from the front opening). Moreover, auger housing 108 can be in communication (e.g., fluid communication) with a chute 116. Moreover, the auger housing 108 can be connected with the chute 116 mechanically, electrically, or both. The chute 116 can extend, for example, above the auger housing 108. The chute 116 can direct discharged snow in a desired direction. In an embodiment, the chute 116 can rotate about a (e.g., vertical) chute axis A_{c}. The chute 116 can include a moveable interface 118 configured to rotate the discharge direction about a horizontal axis. In this regard, the direction and height of discharged snow can be controlled. In certain instances, the direction of at least one of the chute 116 and moveable interface 118 can be controlled by the operator at the handle assembly 110. For instance, a chute lever 126 may be provided on the handle assembly 110 to selectively rotate the chute 116. Additionally or alternatively, a movable flap lever may be provided on the chute 116 to selectively rotate the movable interface 118.

In certain embodiments, handle assembly 110 include a top handle 110c (e.g., as an unbroken unitary piece or having left and right portions to receive a user's left and right hands, respectively). One or more inputs for controlling snow blower 100 may be provided on or proximal to top handle 110c. Although top handle 110c is shown as a single-piece construction handle having left and right portions to receive a user's left and right hands, respectively. In other instances, the handle assembly 110 can include a multi-piece construction (e.g., having multiple discrete handles to receive a user's hands). The top handle 110c can be coupled to one or more additional portions, which extend from the frame 102 to the first and second handles 110a and 110b (e.g., to support the top handle 110c or permit selective height adjustments or storage configurations of the handle assembly 110).

The auger housing 108 generally houses the auger 106. As shown, auger housing 108 may include multiple walls, which house or at least partially enclose auger 106. For instance, auger housing 108 may include a top wall 108a vertically bounding or disposed above auger 106 (e.g., such that the auger 106 is housed below the top wall 108a), a pair of side walls 108b laterally bounding auger 106, and a rear wall 108c transversely bounding or disposed rearward from auger 106. Generally, auger housing 108 defines two or more openings to permit snow therethrough. For instance, auger housing 108 may define an inlet opening 160 (e.g., at a front portion of auger housing 108) to permit snow to the rotatable auger 106. The inlet opening 160 may be defined in front of the rotatable auger 106, such as by a pair of side walls 108b and top wall 108a When assembled, auger 106 may be mounted to frame 102 and disposed rearward from the inlet opening 160. Separately from or in addition to inlet opening 160 auger housing 108 may define an outlet opening 162 to permit snow to flow from rotatable auger 106 (e.g., as motivated by the same) and out of auger housing 108 through outlet opening 162. In some embodiments, outlet opening 162 is defined through top wall 108a. In turn, rotatable auger 106 may be mounted to frame 102 below outlet opening 162 to motivate snow therethrough.

Auger housing 108 can be in communication (e.g., fluid communication) with a chute or chute body 116. Moreover, the auger housing 108 can be connected with the chute 116 mechanically, electrically, or both. The chute 116 can extend, for example, above the auger housing 108. Optionally, chute 116 can include or be provided as a solid, nonpermeable body extending along the chute axis A_{c}, upward or downstream from outlet opening 162.

Whereas the chute 116 directs snow away from the auger 106 in an upward direction, the snow blower 100 may further include a scraper assembly 190 configured to scrape snow from the ground along a path cleared by the auger 106. The scraper assembly 190 may include a scraper bar configured to scrape the ground. The scraper bar can be coupled to the auger 106 or one or more wheels 114 of the snow blower 100. In some aspects, one or more springs (not shown) can be provided between the scraper bar and the auger 106 or wheel(s) 114 such that the scraper bar operates in a spring-loaded manner. For instance, the one or more springs may bias the scraper bar in a downward direction toward the ground relative to the auger housing 108 and the spring(s) may be compressed when the scraper bar contacts the ground along the path.

Turning now to FIGS. 3 through 6, various features of or adjacent to the battery compartment 112 of the snow blower 100 will be described in further detail. The battery compartment 112 has a compartment box or body 164 having a volume 166 and enclosed by a battery compartment cover 168. One or more battery packs 170 may be inserted in the volume 166. For instance, the compartment 112 may include a receiving well 172 forming a battery receiver 174 for each respective battery pack 170. As illustrated, the battery compartment 112 may include multiple (e.g., two or more, such as four) wells 172 spaced apart from each other and thus be configured to receive a corresponding number of battery packs 170 therein. It is noted the present disclosure contemplates the battery compartment 112 may be configured to receive any suitable number of battery packs 170 to power the snow blower 100. Each battery receiver 174 may include one or more electrical contacts provided in a battery terminal 200 disposed within the corresponding battery well 172. Generally, such contacts or battery terminal 200 are/is configured to electrically couple with a respective battery pack 170. In turn, each battery terminal 200 may be in selective electrical communication with the respective battery pack 170. Moreover, the electrical contacts or battery terminals 200 may be in electrical (e.g., wired) connection with a motor, controller, or any other electrically powered component of the snow blower 100 to provide power from the battery pack 170.

Generally, the battery compartment cover 168 may be opened and closed. In other words, the cover 168 may have an open position, in which a user is able to access the volume 166 of the battery compartment 112 (e.g., to insert or remove a battery pack 170) and a closed position, in which the volume 166 is enclosed and the batteries 170 are protected from the environment or in which access to the battery compartment 112 is otherwise restricted. The cover 168 may be pivotably or rotatably coupled to the battery compartment 112 or coupled in any other suitable manner. For instance, the cover 168 may be rotatably mounted to the frame 102 at a top body panel (e.g., of a plurality of body panels) of the frame 102. In some embodiments, the cover 168 is pivotably coupled to the frame 102 as the battery compartment 112 is integral with the frame 102; however, the battery compartment 112 may optionally be separate from the frame 102 in other embodiments of the present disclosure.

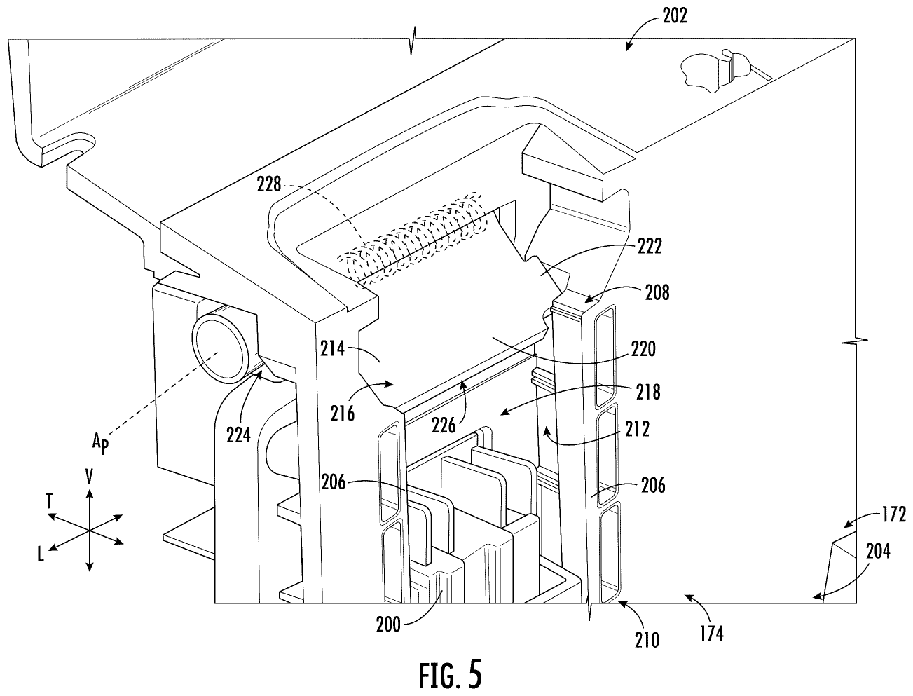

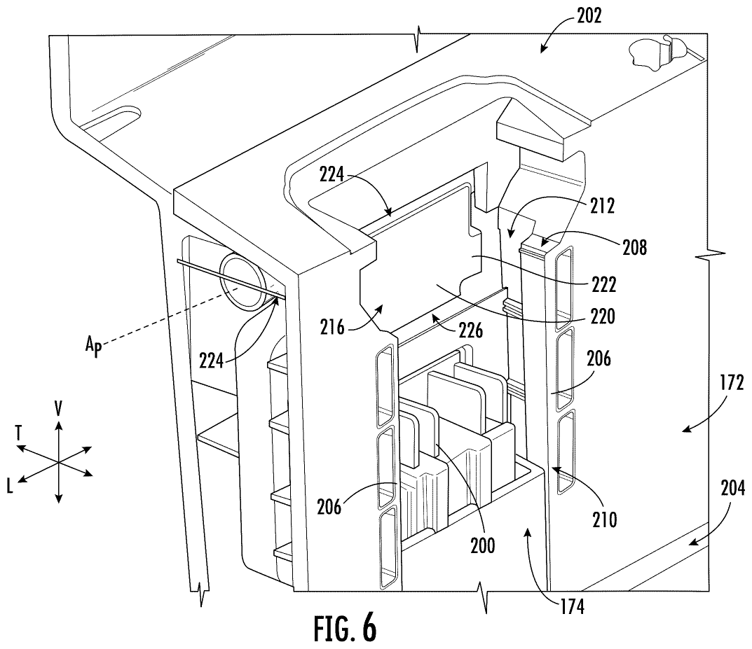

Turning especially to FIGS. 5 and 6, perspective views are provided of a portion of battery compartment 112. Specifically, a single battery well 172 and respective battery receiver 174 are illustrated according to exemplary embodiments of the present disclosure. Although a single battery receiver 174 is illustrated, it is noted multiple similar or identical receivers may further be provided (e.g., in separate or discrete corresponding wells), as would be understood in light of the present disclosure.

As noted above, a battery terminal 200 may be disposed within a battery well 172. In some embodiments, the battery well 172 extends vertically between a top well end 202 and a bottom well end 204. At the top well end 202, a well opening may be defined. The battery terminal 200, by contrast, may be disposed below well opening (e.g., at or proximate to bottom well end 204). A guide rail 206 may extend above battery terminal 200 (e.g., within the battery well 172 to or towards top well end 202). For instance, guide rail 206 may extend (e.g., vertically) between a top rail end 208 (e.g., at or proximal to top well end 202 or distal to bottom well end 204) and a bottom rail end 210 (e.g., at or proximal to bottom well end 204 or distal to top well end 202). Generally, guide rail 206 may serve to guide or partially restrain the movement or mounted position of the battery pack 170. In some such embodiments, guide rail 206 defines a vertical channel 212 (e.g., extending between the top rail end 208 and the bottom rail end 210) within which the battery pack 170 (i.e., a corresponding portion thereof) is slidably received. As shown, the vertical channel 212 may define an open space, such as a continuous horizontal (e.g., transverse) gap between a well wall and a bounding segment of guide rail 206.

It is noted that in optional embodiments, the guide rail 206 may be provided as or as part of a pair of guide rails 206. Thus, the guide rail 206 may include a pair of guide rails 206. As shown, the pair of guide rails 206 may be disposed on opposite horizontal (e.g., lateral) sides of battery terminal 200. Thus, battery terminal 200 may be horizontally (e.g., laterally) bounded by the pair of guide rails 206. Moreover, above the battery terminal 200 a rail (e.g., lateral) gap may be defined to receive a further portion of the battery pack 170.

Separate from or in addition to the guide rail 206, a deflector plate 214 may be provided in the battery receiver 174. As illustrated between FIGS. 5 and 6, deflector plate 214 may be movably mounted above the battery terminal 200 to move (e.g., pivot about a horizontal pivot axis Aₚ) between an obstructed position (FIG. 5) and an unobstructed position (FIG. 6), as will be described in greater detail below. Generally, the deflector plate 214 includes a solid, non-permeable primary body 220 configured to selectively cover at least a portion of the battery terminal 200.

During use, an upper surface 216 of the primary body 220 may be held above the battery terminal 200 and be disposed (e.g., selectively) directly above battery terminal 200. Moreover, when deflector plate 214 covers the battery terminal 200, the upper surface 216 may be directed upward (e.g., such that snow falls onto upper surface 216 instead of battery terminal 200). Optionally, the primary body 220 may be sized and shaped to complement or match the rail gap 218 and, thus, selectively fit within the rail gap 218 (e.g., between the pair of guide rails 206). In some embodiments, one or more side wings 222 may be sized and shaped to complement or match the vertical channel 212 and, thus, selectively fit within the same. For instance, a pair of side wings 222 may extend from opposite lateral sides of the primary body 220 to each be selectively received within a corresponding vertical channel 212.

In some embodiments, a deflector plate 214 is provided in biased engagement with deflector plate 214. For instance, a deflector spring 228 may be mounted above the battery terminal 200. Any suitable spring may be provided, such as a torsion spring, to urge rotation of the deflector plate 214 to or toward a set position, such as the obstructed position. Thus, the deflector spring 228 may bias the deflector plate 214 toward the obstructed position.

When assembled, the deflector plate 214 is generally held or located above the bottom rail end 210 (e.g., relative to the vertical direction V). As shown, the deflector plate 214 may be vertically spaced apart from the bottom rail end 210. Nonetheless, in some embodiments, the deflector plate 214 may also be held below at least a portion of the battery well 172 or guide rail 206. For instance, the deflector plate 214 may be located at a lower position relative to the vertical direction V than the top well end 202. Additionally or alternatively, the deflector plate 214 may be located at a lower position relative to the vertical direction V than the top rail end 208. Thus, relative to the vertical direction V, the deflector plate 214 may side between the top and bottom of the guide rail 206.

Turning now especially to FIG. 5, the deflector plate 214 is illustrated at an obstructed position according to exemplary embodiments. As shown, the obstructed position includes the deflector plate 214 extended across at least a portion of the guide rail 206. Specifically, at least a portion of the deflector plate 214 may be held directly above the battery terminal 200 (e.g., to intersect a vertical projection of the battery terminal 200). In turn, the deflector plate 214 may cover the battery terminal 200. In some embodiments, the primary body 220 continues radially outward from the horizontal pivot axis Aₚ defined by the deflector plate 214. The horizontal gap 218 (e.g., between the pair of guide rails 206) may be occupied by, for instance, the primary body 220 in the obstructed position. In particular, in the obstructed position, the deflector plate 214 (e.g., at or including the primary body 220) may extend from a rear portion of the horizontal gap 218 to a front portion of the horizontal gap 218. The one or more side wings 222 be held or received within a corresponding vertical channel 212 (e.g., further covering or blocking potential openings to the battery terminal 200) in the obstructed position. Notably, snow falling down toward the battery compartment 112 may be blocked from falling into the vertical channel 212 or on the battery terminal 200.

In certain embodiments, the deflector plate 214 is oriented at a sloped or slanted angle in the obstructed position. For instance, the upper surface 216 may be disposed at a non-orthogonal (e.g., non-vertical) angle θ relative to a horizontal direction or plane (i.e., direction or plane perpendicular to the vertical direction V). The non-orthogonal angle θ may be a negative or descending angle from a fixed or rear end 224 (e.g., at or proximal to the pivot axis Aₚ) to a free or forward end 226 (e.g., distal to the pivot axis Aₚ). In turn, the fixed or rear end 224 may be disposed at a higher location than a lower location of the free or forward end 226 relative to the vertical direction V. Nonetheless, as shown, the obstructed position may be non-parallel to the vertical channel 212 or vertical direction V. Snow or debris landing on the deflector plate 214 above the battery terminal 200 may, in turn, be directed (e.g., by gravity) along the upper surface 216 downward and forward apart from the battery terminal 200.

Turning now especially to FIG. 6, the deflector plate 214 is illustrated at an unobstructed position according to exemplary embodiments. As shown, the unobstructed position includes the deflector plate 214 horizontally spaced apart from the battery terminal 200. For instance, although being located at a higher relative location than the battery terminal 200, the deflector plate 214 may be horizontally offset from the battery terminal 200 or a vertical projection thereof. In turn, the battery terminal 200 may be uncovered. Moreover, the horizontal gap 218 may accommodate a portion of a battery pack 170 being coupled or connected to the battery terminal 200. For instance, the battery pack 170 may push the deflector plate 214 to the unobstructed position. Optionally, in the unobstructed position, the deflector plate 214 may be substantially parallel to the vertical channel 212. For instance, the deflector plate 214 may be directed downward and substantially parallel to the vertical channel 212. The side wings 222 may be held outside of the corresponding vertical channels 212.

Further aspects of the invention are provided by one or more of the following embodiments:

A snow blower comprising: a frame; a rotatable auger rotatably mounted to the frame; and a battery compartment attached to the frame to receive a battery pack, the battery compartment comprising a battery terminal in selective electrical communication with the battery pack, a guide rail extending above the battery terminal, and a deflector plate movably mounted above the battery terminal to move between an obstructed position and an unobstructed position, the obstructed position comprising the deflector plate extended across at least a portion of the guide rail directly above the battery terminal to cover the battery terminal, the unobstructed position comprising the deflector plate horizontally spaced apart from the battery terminal to uncover the battery terminal.

The snow blower of any one or more of the embodiments, wherein the guide rail defines a vertical channel within which the battery pack is slidably disposed, wherein the obstructed position comprises the deflector plate extending from a rear portion of the vertical channel to a front portion of the vertical channel.

The snow blower of any one or more of the embodiments, further comprising a compartment door movably mounted to the frame above the battery compartment to selectively restrict access thereto.

A snow blower comprising: a frame; a rotatable auger rotatably mounted to the frame; a battery compartment attached to the frame to receive a battery pack, the battery compartment comprising a battery terminal in selective electrical communication with the battery pack, a guide rail extending above the battery terminal, the guide rail defining a vertical channel within which the battery pack is slidably disposed, and a deflector plate movably mounted above the battery terminal to move between an obstructed position and an unobstructed position, the obstructed position comprising the deflector plate extended directly above the battery terminal from a rear portion of the vertical channel to a front portion of the vertical channel to cover the battery terminal, the unobstructed position comprising the deflector plate horizontally spaced apart from the battery terminal to uncover the battery terminal; and a compartment door movably mounted to the frame above the battery compartment to selectively restrict access thereto.

The snow blower of any one or more of the embodiments, wherein the deflector plate defines a horizontal pivot axis about which the deflector plate is pivotable between the obstructed position and the unobstructed position.

The snow blower of any one or more of the embodiments, wherein the battery compartment further comprises a deflector spring mounted above the battery terminal in biased engagement with the deflector plate, the deflector spring biasing the deflector plate toward the obstructed position.

The snow blower of any one or more of the embodiments, wherein, at the obstructed position, the deflector plate defines an upper surface disposed at a non-orthogonal angle relative to a horizontal direction.

The snow blower of any one or more of the embodiments, wherein, at the unobstructed position, the deflector plate is directed downward and substantially parallel to the vertical channel.

The snow blower of any one or more of the embodiments, wherein the guide rail extends vertically between a top rail end and a bottom rail end, and wherein the deflector plate is disposed below the top rail end.

The snow blower of any one or more of the embodiments, wherein the guide rail comprises a pair of guide rails disposed on opposite lateral sides of the battery terminal, wherein the deflector plate comprises a primary body disposed between the pair of guide rails and a side wing extending laterally from the primary body.

The snow blower of any one or more of the embodiments, wherein the side wing is rotatably received within one guide rail of the pair of guide rails.

The snow blower of any one or more of the embodiments, wherein battery compartment further comprises a first battery well within which the battery terminal and the guide rail are held, a second battery well spaced apart from the first battery well to receive a second battery pack, a second battery terminal disposed within the second battery well in selective electrical communication with the second battery pack, a second guide rail extending above the second battery terminal within the second battery well, and a second deflector plate movably mounted above the second battery terminal to move between an obstructed position and an unobstructed position, the obstructed position comprising the second deflector plate extended across at least a portion of the second guide rail directly above the second battery terminal to cover the second battery terminal, the unobstructed position comprising the second deflector plate horizontally spaced apart from the second battery terminal to uncover the second battery terminal.

An apparatus as shown and described in one or more embodiments herein.

A system configured to operate in accordance with any one or more of the embodiments disclosed herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A snow blower comprising:
a frame;
a rotatable auger rotatably mounted to the frame; and
a battery compartment attached to the frame to receive a battery pack, the battery compartment comprising
a battery terminal in selective electrical communication with the battery pack,
a guide rail extending above the battery terminal, and
a deflector plate movably mounted above the battery terminal to move between an obstructed position and an unobstructed position, the obstructed position comprising the deflector plate extended across at least a portion of the guide rail directly above the battery terminal to cover the battery terminal, the unobstructed position comprising the deflector plate horizontally spaced apart from the battery terminal to uncover the battery terminal.

2. The snow blower of claim 1, wherein the deflector plate defines a horizontal pivot axis about which the deflector plate is pivotable between the obstructed position and the unobstructed position.

3. The snow blower of claim 1, wherein the battery compartment further comprises a deflector spring mounted above the battery terminal in biased engagement with the deflector plate, the deflector spring biasing the deflector plate toward the obstructed position.

4. The snow blower of claim 1, wherein the guide rail defines a vertical channel within which the battery pack is slidably disposed, wherein the obstructed position comprises the deflector plate extending from a rear portion of the vertical channel to a front portion of the vertical channel.

5. The snow blower of claim 4, wherein, at the obstructed position, the deflector plate defines an upper surface disposed at a non-orthogonal angle relative to a horizontal direction.

6. The snow blower of claim 4, wherein, at the unobstructed position, the deflector plate is directed downward and substantially parallel to the vertical channel.

7. The snow blower of claim 1, wherein the guide rail extends vertically between a top rail end and a bottom rail end, and wherein the deflector plate is disposed below the top rail end.

8. The snow blower of claim 1, wherein the guide rail comprises a pair of guide rails disposed on opposite lateral sides of the battery terminal, wherein the deflector plate comprises a primary body disposed between the pair of guide rails and a side wing extending laterally from the primary body.

9. The snow blower of claim 8, wherein the side wing is rotatably received within one guide rail of the pair of guide rails.

10. The snow blower of claim 1, further comprising a compartment door movably mounted to the frame above the battery compartment to selectively restrict access thereto.

11. The snow blower of claim 1, wherein battery compartment further comprises
a first battery well within which the battery terminal and the guide rail are held,
a second battery well spaced apart from the first battery well to receive a second battery pack,
a second battery terminal disposed within the second battery well in selective electrical communication with the second battery pack,
a second guide rail extending above the second battery terminal within the second battery well, and
a second deflector plate movably mounted above the second battery terminal to move between an obstructed position and an unobstructed position, the obstructed position comprising the second deflector plate extended across at least a portion of the second guide rail directly above the second battery terminal to cover the second battery terminal, the unobstructed position comprising the second deflector plate horizontally spaced apart from the second battery terminal to uncover the second battery terminal.

12. A snow blower comprising:
a frame;
a rotatable auger rotatably mounted to the frame;
a battery compartment attached to the frame to receive a battery pack, the battery compartment comprising
a battery terminal in selective electrical communication with the battery pack,
a guide rail extending above the battery terminal, the guide rail defining a vertical channel within which the battery pack is slidably disposed, and
a deflector plate movably mounted above the battery terminal to move between an obstructed position and an unobstructed position, the obstructed position comprising the deflector plate extended directly above the battery terminal from a rear portion of the vertical channel to a front portion of the vertical channel to cover the battery terminal, the unobstructed position comprising the deflector plate horizontally spaced apart from the battery terminal to uncover the battery terminal; and
a compartment door movably mounted to the frame above the battery compartment to selectively restrict access thereto.

13. The snow blower of claim 12, wherein the deflector plate defines a horizontal pivot axis about which the deflector plate is pivotable between the obstructed position and the unobstructed position.

14. The snow blower of claim 12, wherein the battery compartment further comprises a deflector spring mounted above the battery terminal in biased engagement with the deflector plate, the deflector spring biasing the deflector plate toward the obstructed position.

15. The snow blower of claim 12, wherein, at the obstructed position, the deflector plate defines an upper surface disposed at a non-orthogonal angle relative to a horizontal direction.

16. The snow blower of claim 12, wherein, at the unobstructed position, the deflector plate is directed downward and substantially parallel to the vertical channel.

17. The snow blower of claim 12, wherein the guide rail extends vertically between a top rail end and a bottom rail end, and wherein the deflector plate is disposed below the top rail end.

18. The snow blower of claim 12, wherein the guide rail comprises a pair of guide rails disposed on opposite lateral sides of the battery terminal, wherein the deflector plate comprises a primary body disposed between the pair of guide rails and a side wing extending laterally from the primary body.

19. The snow blower of claim 18, wherein the side wing is rotatably received within one guide rail of the pair of guide rails.

20. The snow blower of claim 12, wherein battery compartment further comprises
a first battery well within which the battery terminal and the guide rail are held,
a second battery well spaced apart from the first battery well to receive a second battery pack,
a second battery terminal disposed within the second battery well in selective electrical communication with the second battery pack,
a second guide rail extending above the second battery terminal within the second battery well, and
a second deflector plate movably mounted above the second battery terminal to move between an obstructed position and an unobstructed position, the obstructed position comprising the second deflector plate extended across at least a portion of the second guide rail directly above the second battery terminal to cover the second battery terminal, the unobstructed position comprising the second deflector plate horizontally spaced apart from the second battery terminal to uncover the second battery terminal.
